(19) United States
(12) Patent Application Publication
(10) Pub. No.: US 2012/0053990 A1
(43) Pub. Date: Mar. 1, 2012

(54) SYSTEM AND METHOD FOR PREDICTING CUSTOMER CHURN

(75) Inventors: Oren Pereg, Amikam (IL); Tzach Ashkenazi, Petach-Tikva (IL); Moshe Wasserblat, Maccabim (IL); Ezra Daya, Petach-Tikva (IL); Oshrat Kfir, Tel Mond (IL); Hila Lam, Tel Aviv (IL); Amir Rubin, Tel Aviv (IL); Eyal Hurvitz, Ramat Gan (IL)

(73) Assignee: Nice Systems Ltd., Ra'anana (IL)

(21) Appl. No.: 13/291,117

(22) Filed: Nov. 8, 2011

Related U.S. Application Data
(63) Continuation-in-part of application No. 12/116,228, filed on May 7, 2008.

(51) Int. Cl. G06Q 30/02

(52) U.S. Cl. 705/7.31

(57) ABSTRACT

A computerized method of predicting customer churn from an organization, including: receiving at a computer server a recorded customer interaction with an agent of the organization; analyzing the received customer interaction to extract basic features that provide an indication regarding the churn probability of the customer; extracting the entity information of the customer from the recorded interaction; retrieving from a database accessible by the server previous interactions for the same entity and extracting advanced features that provide an indication regarding the churn probability of the customer by comparing multiple interactions of the same entity; predicting a churn probability for the received interaction by applying a statistical customer churn model to the extracted basic features and extracted advanced features; and wherein the interaction and the previous interactions are recordable from more than one type of communication channel by which the customer can communicate with the organization.

### RELATED APPLICATIONS

This application claims priority as a continuation in part of U.S. application Ser. No. 12/116,228 filed May 7, 2008 the disclosure of which is incorporated herein by reference.

### FIELD OF THE INVENTION

The present invention relates generally to the prediction of organization customer churn based on interactions between the customer and the organization.

### BACKGROUND OF THE INVENTION

Individual customers are the main source of income for many business organizations. Business organizations tend to spend a lot of money and effort in acquiring new customers but generally tend to spend less effort in assuring that existing customers don't leave. Customers leaving are referred to herein as customer churn and may also be referred to as customer attrition, turnover, or defection.

Dealing with customers can be performed on a personal level or in mass, for example acquiring new customers or providing notifications to customers may be practiced by mass publicity or by individual contact. Many systems deal with individual contact with customers, for example sales and support by a call center using the telephone, or interactions using fax, email, chat an organizational website or other means.

Many systems record customer interactions, for example recording conversations at call centers, storing customer relationship management (CRM) data, storing messages sent from the customer and responses provided to the customer. Such information may be stored by the organization; however an agent handling one interaction may be unaware of previous interactions or might not be equipped to handle interactions of a type that is different from the ones he or she handles, for example an agent at a call center may be unaware of emails or web site activity of the customer. Alternatively, the agent may be aware of previous interactions with the customer but may not see their significance so that unless a customer explicitly states to the agent that they plan to leave the organization they might have no knowledge that the customer might churn based on previous interactions.

Retrospective analysis of a churned customer may show that the signs were available that the customer was on the verge of churning and churning could have been prevented by remedial actions. However since each interaction does not provide a clear indication to that effect no action was taken by the agents dealing with the customer.

Thus there is a need in the art for a system and method to enhance automatic analysis of customer interactions and prediction of the probability that a customer will churn.

### SUMMARY OF THE INVENTION

An aspect of an embodiment of the invention, relates to a system and method for automatically predicting customer churn from an organization based on recorded interactions of the customer with the organization. The interactions are recordable from more than one type of interaction channel by which the customer can communicate with the organization, for example by conducting a voice conversation with an agent of the organization, sending an email to the organization, using chat to communicate with an agent of the organization and accessing a web site controlled by the organization. A general purpose computer serves as a computer server executing an application for analyzing the recorded interactions between the customers and the organization. The server receives the recorded interactions and analyzes them to extract basic features that provide an indication regarding the churn probability of the customer. Additionally, the server extracts entity information of the customer from the recorded interaction. Afterwards the server retrieves previous interactions of the same entity and extracts advanced features that provide an indication regarding the churn probability of the customer by comparing multiple interactions of the same entity, for example based on the communication channel used in the current interaction relative to the standard communication channel used by the customer in past interactions, or the frequency of the interactions in the past month or year.

The application uses the extracted features and applies them to a statistical model to determine a probability churn value for the customer.

In some embodiments of the invention, the application accesses a CRM application using the extracted entity of the customer and extracts additional advanced features related to the churn probability of the customer based on the CRM data. Optionally, at least one of the previous interactions is from a different communication channel than the current interaction, since some of the interactions may be initiated by an agent of the organization and some may be initiated by the customer and the communication channel will be selected by the initiator.

There is thus provided according to an exemplary embodiment of the invention, a computerized method of predicting customer churn from an organization, including:

receiving at a computer server a recorded customer interaction with an agent of the organization;

analyzing the received customer interaction to extract basic features that provide an indication regarding the churn probability of the customer;

extracting the entity information of the customer from the recorded interaction;

retrieving from a database accessible by the server previous interactions for the same entity and extracting advanced features that provide an indication regarding the churn probability of the customer by comparing multiple interactions of the same entity;

predicting a churn probability for the received interaction by applying a statistical customer churn model to the extracted basic features and extracted advanced features; and

wherein the interaction and the previous interactions are recordable from more than one type of communication channel by which the customer can communicate with the organization.

In an exemplary embodiment of the invention, the method further includes retrieving from a CRM application data related to the same entity and extracting advanced features that provide an indication regarding the churn probability of the customer based on the CRM data. Optionally, the communication channels are selected from the group consisting of email communication, voice communication, web site communication and chat communications.

In an exemplary embodiment of the invention, at least one of the previous interactions is from a different communication channel than the received interaction. Optionally, the statistical customer churn model is created from the features extracted from the interactions of a selected group of customers with a determination if the customer churned or not.

In an exemplary embodiment of the invention, extraction of the entity information is based on details related to the type of communication channel. Alternatively or additionally, extraction of the entity information is based on details recorded by the agent handling the interaction. Optionally, the basic features are selected from the group consisting of: categories to which the agent handling the interaction categorized the interaction; keywords identified in the interaction; emotion or sentiment found in the interaction; the initiator of the interaction; the date of the interaction; the Interaction channel type. In an exemplary embodiment of the invention, the advanced features are selected from the group consisting of: channel type sequence of interactions, repeating topics in the interactions, time interval between interactions, and sentiment trends in a sequence of interactions.

There is further provided according to an exemplary embodiment of the invention, a system for predicting customer churn, including:

a computer server;

a database accessible by the computer server;

a computer application for predicting customer churn from an organization;

wherein the computer server receives recorded customer interactions between customers and agents of the organization, and applies the computer application to predict customer churn for the interactions;

wherein the application includes:
an analysis layer for extracting basic features that provide an indication regarding the churn probability of the customer;
an entity layer for extracting the entity information of the customer from the recorded interaction; and for retrieving from the database previous interactions for the same entity and extracting advanced features that provide an indication regarding the churn probability of the customer by comparing multiple interactions of the same entity;
a score layer for predicting a chum probability for the received interaction by applying a statistical customer churn model to the extracted basic features and extracted advanced features; and

wherein the interaction and the previous interactions are recordable from more than one type of communication channel by which the customer can communicate with the organization.

Additionally there is provided according to an exemplary embodiment of the invention, a non-transient computer storage medium, including:

a computer application for executing on a general purpose computer for predicting customer churn from an organization;

wherein the general purpose computer serves as a server that receives recorded customer interactions between customers and agents of the organization, and applies the computer application to predict customer churn for the interactions;

wherein the application includes:
an analysis layer for extracting basic features that provide an indication regarding the churn probability of the customer;
an entity layer for extracting the entity information of the customer from the recorded interaction; and for retrieving from the database previous interactions for the same entity and extracting advanced features that provide an indication regarding the churn probability of the customer by comparing multiple interactions of the same entity;
a score layer for predicting a churn probability for the received interaction by applying a statistical customer churn model to the extracted basic features and extracted advanced features; and

wherein the interaction and the previous interactions are recordable from more than one type of communication channel by which the customer can communicate with the organization.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a chum prediction system, according to an exemplary embodiment of the invention;

FIG. 2 is a schematic illustration of a chum prediction application in a chum prediction system, according to an exemplary embodiment of the invention;

FIG. 3 is a flow diagram of the creation of a customer chum model, according to an exemplary embodiment of the invention; and

FIG. 4 is a flow diagram of customer chum prediction, according to an exemplary embodiment of the invention.

### DETAILED DESCRIPTION

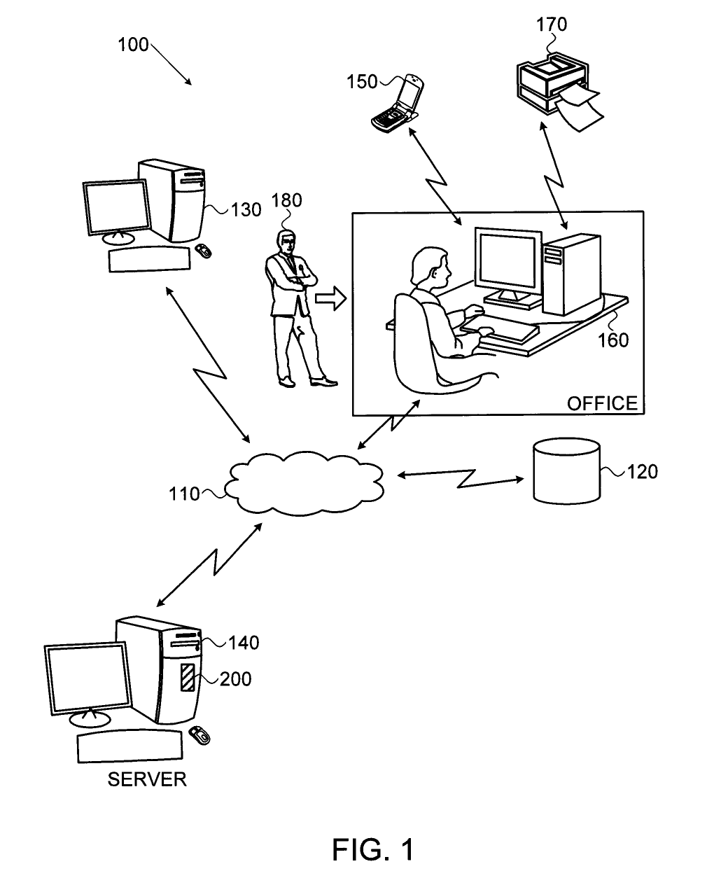

FIG. 1 is a schematic illustration of a churn prediction system 100, according to an exemplary embodiment of the invention. In an exemplary embodiment of the invention, a customer 180 may interact with an organization using various communication channels, for example using a telephone 150, using a fax 170, and using a computer workstation 130 or other types of communication devices such as mobile telephones, laptop computers, handheld computers and the like. Optionally, the customer 180 may send an email to the organization or access a website of the organization. Alternatively or additionally, the customer 180 may personally visit an office 160 of the organization to speak with a representative of the organization.

In an exemplary embodiment of the invention, the interactions with the customer 180 are recorded in a database 120. Optionally, a server 140 is installed with a churn prediction application 200. Server 140 is accessible over a network 110 by the sources that record the interactions with the customer. In an exemplary embodiment of the invention, the churn prediction application 200, collects the recorded customer interactions and stores them in database 120. Optionally, each interaction is analyzed to determine the status of the customer 180, for example if the stored interactions with the latest interaction, provide an indication that the customer is a potential churn customer. In an exemplary embodiment of the invention, server 140 provides notification to agents of the organization dealing with the customers if a customer is a potential churn customer.

In some embodiments of the invention, the determination and indication may be performed online, during the interaction with customer 180. Alternatively, the determination may be performed in a batch process based on the stored data of each customer; the indication may be stored with the customer data and may be presented to the agent whenever the customer 180 forms contact or whenever the agent accesses the customer's data.

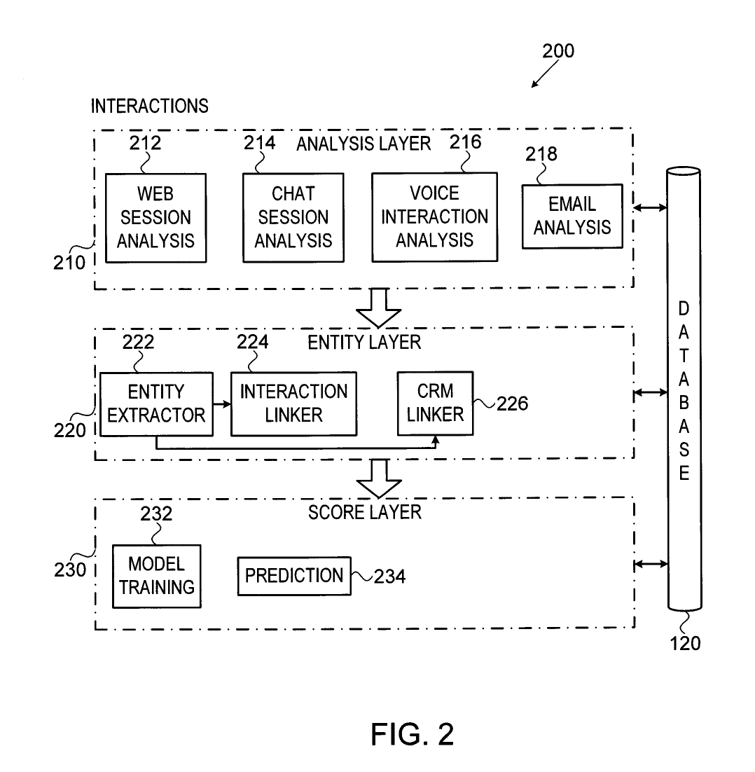

FIG. 2 is a schematic illustration of churn prediction application 200 in chum prediction system 100, according to an exemplary embodiment of the invention. Optionally, churn prediction application 200 includes three layers:

1. An analysis layer 210 that deals with basic analysis of every recorded customer-organization interaction;

2. An entity layer 220 that deals with identifying the customer in every interaction, connecting between the various interactions stored in the database; and advanced analysis of the interaction relative to other interactions;

3. A score layer 230 that deals with providing a churn score to each interaction and combinations of interactions.

In an exemplary embodiment of the invention, the analysis layer 210 includes components to deal with various methods of customer-organization interactions. The components include a web session analysis component 212, a chat session analysis component 214, a voice interaction analysis component 216 and an email analysis component 218. Optionally, the analysis layer 210 may include other components to deal with other types of interactions (e.g. fax, face to face meetings and other types).

In an exemplary embodiment of the invention, the web session analysis component 212 extracts features from a customer web session with the web site of the organization, for example, which pages were viewed by the customer, the browsing sequence of the customer, actions performed by the customer during the session, categorization of the session into a set of categories based on the topics dealt with by the customer at the web site and other features.

In an exemplary embodiment of the invention, the chat session analysis component 214 analyzes chat sessions conducted with the customer and extracts features related to the customer interaction with the organization. Optionally, the features may include extraction of keywords, interaction length, sentiment detection from the content of the chat, extraction of the main reason for the interaction, and categorization of the session into a set of categories by the agent handling the session for the organization and other features.

In an exemplary embodiment of the invention, the voice interaction analysis component 216 analyzes speech sessions conducted with the customer and extracts features related to the customer interaction with the organization. Optionally, the features may include detection and extraction of keywords, interaction length, emotion detection from the content and tone of the conversation, extraction of the main reason for the interaction, and categorization of the session into a set of categories by the agent handling the session for the organization and other features.

In an exemplary embodiment of the invention, the email analysis component 218 analyzes email messages sent by the customer to the organization and extracts features related to the customer interaction with the organization. Optionally, the features may include detection and extraction of keywords in the emails, detection of sentiment from the content of the emails, extraction of the main reason for the interaction, and categorization of the email into a set of categories by the agent handling the emails for the organization and other features.

In an exemplary embodiment of the invention, analysis layer 210 may include fax analysis, face to face interaction analysis and other interaction methods.

In an exemplary embodiment of the invention, entity layer 220 includes an entity extraction component 222. Optionally, the entity extraction component 222 extracts identification details of the customer from the details of the interaction. In some embodiments of the invention, the extracted details are extracted from information related to the type of communication channel, for example from the customers IP address (during web access), the customers email (during email access), the customers unique ID (for chat access), the customers telephone number or responses to specific key questions the customer is asked by the agent. Alternatively, the identification details recorded by the agent dealing with the customer may be extracted by entity extraction component 222 and attached to the interaction information.

In an exemplary embodiment of the invention, after identifying the customer by entity extraction component 222 an interaction linker component 224 links the features extracted by analysis layer 210 with the customer identity determined by entity extraction component 222. Optionally, the results of the interaction linker component are stored in database 120 for future access.

In an exemplary embodiment of the invention, the basic features extracted from a single interaction may include:

1. Categories to which an agent categorized the interaction with or without a relevance score;

2. Keywords identified in the interaction;

3. If emotion/sentiment was found in the interaction;

4. Who initiated the interaction (inbound/outbound);

5. The date of the interaction’

6. Interaction channel type (email, chat, web, telephone, fax etc.) Additionally, interaction linker component 224 may determine further more advanced features by comparing the current results with previous results recorded for the same customer 180, for example:

1. Channel type sequence of interactions, for example email, email then telephone, which may indicate urgency due to unsolved issues;

2. Repeating topics in the interactions, this may indicate that a problem is not solved;

3. Time interval between interactions, this may hint to the urgency of the issue.

4. Sentiment trends in a sequence of interactions.

In an exemplary embodiment of the invention, entity layer 220 also includes a customer relationship management (CRM) component 226 that extracts features related to operations the customer performed in his account in the past. Optionally, customer relationship management component 226 extracts features such as:

A. Details related to the identity of the customer:

1. Seniority—How long the customer has been with the organization.

2. Demographics—Details related to the cultural background of the customer.

3. Location—details related to the geographical location of the customer (e.g. if the organizations products are commonly used in that location or if a competitors products are more common there).

B. Details related to the operations performed by the customer:

1. Items purchased by the customer.

2. Items returned by the customer.

3. Customer usage pattern and pattern deviation.

4. A CRM based churn score.

In an exemplary embodiment of the invention, churn prediction is based on analysis of the extracted features that are extracted by analysis layer 210 and entity layer 220 as explained above. Some features provide indications directly related to the user interactions, for example explicit churn threat, consistent negative sentiment overtime and so forth. Other features provide circumstantial evidence, for example the customer's age, location, past purchases, demographic details, fields of interest, methods of contact (communication channels) and the like. Some parameters may statistically fit patterns of churning customers and some may fit non-churning customers.

In an exemplary embodiment of the invention, the features resulting from entity layer 220 are provided to the score layer 230. The score layer 230 includes a model training component 232 and a prediction component 234. Optionally, the module training component 232 is provided from database 120 with a set of customers, the outcome of their interactions (if the customers churned or not), and the features extracted from their interactions. Optionally, module training component 232 builds a statistical model that will be used to predict the probability of churning of a customer. In an exemplary embodiment of the invention, prediction component 234 will use the statistical module to evaluate a single customer interaction and/or the entire status of a customer based on all or some of the customer's interactions, for example from the past year or past month. Optionally, prediction component 234 will provide a churn score representing the probability that the customer will churn.

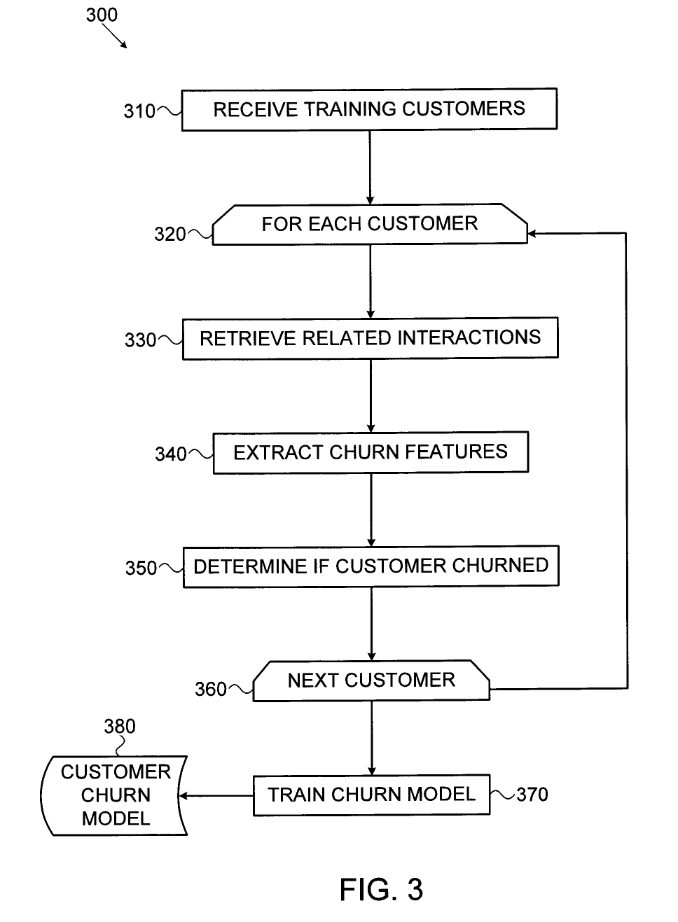

FIG. 3 is a flow diagram 300 of the creation of a customer chum model, according to an exemplary embodiment of the invention. In an exemplary embodiment of the invention, a set of customers is selected to train the statistical module. Optionally, the training process may be performed periodically or at selected times to enhance the accuracy of the statistical module. In some embodiments of the invention, all of the customers are analyzed. Alternatively, only some of the customers are analyzed for example the most veteran customers.

In an exemplary embodiment of the invention, the list of selected customers is received by model training component 232 (310). Optionally, for each customer (320) model training component 232 accesses database 120 and retrieves the interactions related to the customer (330). The analysis layer 210 analyzes the interactions and entity layer 220 extracts features (340) of the interactions and further analyzes the interactions relative to each other. Alternatively or additionally, the features may have already been extracted in real time (e.g. when the interaction was recorded) and are merely extracted from the database 120. Additionally, database 120 records a churn mark for each customer indicating if the customer churned or not, for example canceled their subscription to a service provided by the organization, returned a product or turned down offers from sales representatives and acquired the service or product at a competitor. In an exemplary embodiment of the invention, module training component 232 determines from database 120 if the customer churned or not (350). Then module training component 232 continues to extract the features of the next customer (360) until the details of all the selected customers have been processed.

In an exemplary embodiment of the invention, module training component 232 uses the extracted features to train (370) a churn model 380. Optionally, churn model 380 can be a decision tree, a SVM model, a neural network, a transient model such as CRF or similar models. In an exemplary embodiment of the invention, when using a SVM model, lib-SVM can be used to train the model. Optionally, a single line is input for each customer. Each line includes a chum mark indicating if the customer churned or not. The chum mark is followed by a list of the features extracted from the customer's interactions with a score for the feature. In an exemplary embodiment of the invention, the resulting churn model 380 can be represented by a set of vectors, formed from a subset of the input data, with their corresponding weights.

Optionally, prediction component 234 will use churn model 380 to accept as input customer identity details and a recorded interaction and provide as output a probability value indicating a level of chum of the customer based on the current interaction and/or the customer's previous interactions.

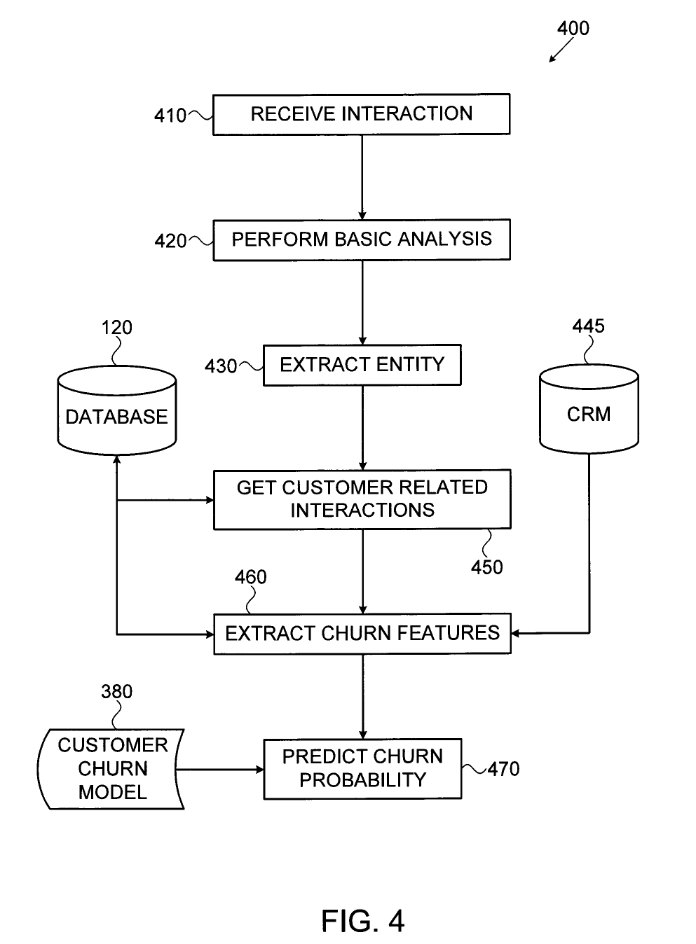

FIG. 4 is a flow diagram 400 of customer churn prediction, according to an exemplary embodiment of the invention. In an exemplary embodiment of the invention, an interaction with a customer is received (410) by the organization. Optionally, the interaction is analyzed (420) by analysis layer 210 to extract basic features for the interaction. Then entity layer 220 extracts (430) the entity (e.g. customer identity) of the interaction, so that previous interactions of the customer can be retrieved (450) from database 120. After retrieving previous interactions interaction linker component 224 and customer relationship management component 226 extract (460) more advanced churn features based on the current interaction, previous interactions and CRM data from a CRM application 445. In an exemplary embodiment of the invention, prediction component 234 uses churn model 380 to predict (470) churn probability of the customer based on the extracted features.

In some embodiments of the invention, churn probability is only calculated for specific types of interactions, for example:

1. Billing related interactions;

2. Customers with a minimum number of interactions;

3. Interactions that convey emotion or sentiment from the customer;

4. Interactions having specific keywords that were detected;

5. Interactions of veteran customers;

6. Interactions of customers that purchased items from the organization within a specific time interval in the past (e.g. the last half year).

Optionally, the criteria for calculating churn probability or not for a specific interaction may be based on a Boolean combination of conditions.

In an exemplary embodiment of the invention, the churn probability score can be used to identify high risk customers and pass on their identity to a special customer retention team or to alert an agent dealing with the customer. Alternatively or additionally, the churn probability score can be used to provide volume reports or trend graphs.

In an exemplary embodiment of the invention, in an SVM model the score can be calculated using the following formula:

$$f ( z ) = {\sum }_{{x}_{i} ∈ S}^{ } {α}_{i} K ( z , {x}_{i} )$$

Where Z is the feature vector of the customer for which churn risk is predicted; S are the support vectors obtained from the SVM training procedure, along with the weights αᵢ which correspond with the features; and K is the kernel function used during the training phase.

The feature vector Z includes all feature values of all the features being used in the model. Among the numerical features, some are continuous, such as time interval between interactions and some may be modeled as discrete by placing them into predefined ranges (e.g. longevity of 1-2 years, over 2 years and less than one year). Nominal features, most notably keywords, key phrases etc., are commonly treated either as binary features, where the numerical value 1 indicates the occurrence of, e.g., a certain key phrase in an interaction and 0 indicated its absence; or, as discrete features that provide the count or frequency of a certain key phrase in an interaction or a series of interactions.

An example of features is provided in the table below. The example illustrates 2 numerical features: total call time (in seconds) of a customer and the average interval between calls (in days). It also illustrates a partial set of nominal features, each standing for a topic (a key phrase that was found to be central in the collection of interactions and is therefore called a topic). The value of each nominal topic feature is either 1 or 0; 1 if the topic occurs in one of the customer's interactions, and 0 otherwise. Optionally, the number of features in a model may be less than 100 or greater than 100, for example around 300. However the number may vary according to the nature and scale of available data.

In the table below, each line represents a vector (excluding the ID field):

| Cust ID | Total_call_time | Call_int_time | Topic_rating | Topic_coverage | Topic_high |
|---|---|---|---|---|---|
| 3342 | 488 | 67.32 | 1 | 0 | 0 |
| 3343 | 583 | 15.43 | 0 | 1 | 0 |
| 3344 | 798 | 443.34 | 0 | 0 | 0 |
| 3345 | 1012 | 109.00 | 0 | 0 | 1 |
| 3346 | 168 | 98.54 | 0 | 0 | 0 |
| 3347 | 265 | 13.90 | 0 | 0 | 0 |
| 3348 | 2432 | 249.62 | 1 | 0 | 0 |

The resulting feature values are a result of a fine-tuning process where standard techniques are used for optimization like scaling (adapting values to fit a certain scale). Note that the process of feature extraction and the calculation of each feature value are usually similar during model training (out of labeled training examples) and during model application (where churn risk is calculated by the model).

As stated above S is the set of support vectors computed at the SVM training phase. These, along with the feature weight values, constitute the SVM model.

The kernel function K is predefined before the training phase. It is a part of each SVM implementation. Typically, there are several known alternatives for kernel functions that are tested and then selected based on model performance. Kernel functions are needed where linear separation between the positive population (churners) and the negative population (non-churners) is not available.

In an exemplary embodiment of the invention, the customer is considered a high churn risk if the above formula produces a score higher than a specified threshold value 0. Optionally, the threshold value can be determined as follows: based on the training data, a graph can be produced showing precision and recall values for each threshold value. The range of possible threshold values is essentially the same as the range for the prediction function above (f(z)). Optionally, for each threshold value 0, precision is the number of actual churners with f(z) equal or above 0 divided by the total number of customers with f(z) equal or above 0. Recall is the ratio of actual churner with f(z) equal or above 0 divided by the total number of actual churners. In the formulae below, the predicate churned(z) means actual churning according to labeled data.

$$recall = \frac{\vert \{ z : f ( z ) \geq θ ⋀ churned ( z ) \} \vert}{\vert \{ z : churned ( z ) \} \vert}$$

$$precision = \frac{\vert \{ z : f ( z ) \geq θ ⋀ churned ( z ) \} \vert}{\vert \{ z : f ( z ) \geq θ \} \vert}$$

In an exemplary embodiment of the invention, the value of θ is determined by selecting a cutoff value of a certain precision-recall combination. In precision-oriented applications where avoiding false positives is more important than missing true positives, the recall value is compromised. In recall-oriented applications the precision may be compromised.

At prediction time, the value of f(z) is computed as a customer is considered as a churner if f(z) is equal or above θ.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A computerized method of predicting customer churn from an organization, comprising:
receiving at a computer server a recorded customer interaction with an agent of the organization;
analyzing the received customer interaction to extract basic features that provide an indication regarding the churn probability of the customer;
extracting the entity information of the customer from the recorded interaction;
retrieving from a database accessible by the server previous interactions for the same entity and extracting advanced features that provide an indication regarding the churn probability of the customer by comparing multiple interactions of the same entity;
predicting a churn probability for the received interaction by applying a statistical customer churn model to the extracted basic features and extracted advanced features; and
wherein said interaction and said previous interactions are recordable from more than one type of communication channel by which the customer can communicate with the organization.

2. A method according to claim 1 further comprising retrieving from a CRM application data related to the same entity and extracting advanced features that provide an indication regarding the churn probability of the customer based on the CRM data.

3. A method according to claim 1, wherein said communication channels are selected from the group consisting of email communication, voice communication, web site communication and chat communications.

4. A method according to claim 1, wherein at least one of said previous interactions is from a different communication channel than said received interaction.

5. A method according to claim 1, wherein said statistical customer churn model is created from the features extracted from the interactions of a selected group of customers with a determination if the customer churned or not.

6. A method according to claim 1, wherein extraction of the entity information is based on details related to the type of communication channel.

7. A method according to claim 1, wherein extraction of the entity information is based on details recorded by the agent handling the interaction.

8. A method according to claim 1, wherein the basic features are selected from the group consisting of: categories to which the agent handling the interaction categorized the interaction; keywords identified in the interaction; emotion or sentiment found in the interaction; the initiator of the interaction; the date of the interaction; the Interaction channel type.

9. A method according to claim 1, wherein the advanced features are selected from the group consisting of: channel type sequence of interactions, repeating topics in the interactions, time interval between interactions, and sentiment trends in a sequence of interactions.

10. A system for predicting customer churn, comprising:
a computer server;
a database accessible by the computer server;
a computer application for predicting customer churn from an organization;
wherein said computer server receives recorded customer interactions between customers and agents of the organization, and applies the computer application to predict customer chum for the interactions;
wherein said application comprises:
an analysis layer for extracting basic features that provide an indication regarding the chum probability of the customer;
an entity layer for extracting the entity information of the customer from the recorded interaction; and for retrieving from the database previous interactions for the same entity and extracting advanced features that provide an indication regarding the chum probability of the customer by comparing multiple interactions of the same entity;
a score layer for predicting a chum probability for the received interaction by applying a statistical customer chum model to the extracted basic features and extracted advanced features; and
wherein said interaction and said previous interactions are recordable from more than one type of communication channel by which the customer can communicate with the organization.

11. A non-transient computer storage medium, comprising:
a computer application for executing on a general purpose computer for predicting customer chum from an organization;
wherein said general purpose computer serves as a server that receives recorded customer interactions between customers and agents of the organization, and applies the computer application to predict customer chum for the interactions;
wherein said application comprises:
an analysis layer for extracting basic features that provide an indication regarding the chum probability of the customer;
an entity layer for extracting the entity information of the customer from the recorded interaction; and for retrieving from the database previous interactions for the same entity and extracting advanced features that provide an indication regarding the churn probability of the customer by comparing multiple interactions of the same entity;
a score layer for predicting a churn probability for the received interaction by applying a statistical customer churn model to the extracted basic features and extracted advanced features; and
wherein said interaction and said previous interactions are recordable from more than one type of communication channel by which the customer can communicate with the organization.
